(19) United States
(12) Patent Application Publication
(10) Pub. No.: US 2014/0260939 A1
(43) Pub. Date: Sep. 18, 2014

(54) EXPLOSIVE ORDINANCE DISPOSAL (EOD) UNITIZED BOMB DISPOSAL SUIT

(71) Applicants: Murray L. Neal, Missoula, MT (US); Peter Faucetta, New York, NY (US)

(72) Inventor: Murray L. Neal, Missoula, MT (US)

(73) Assignee: Murray L. Neal, Missoula, MT (US)

(21) Appl. No.: 14/213,555

(22) Filed: Mar. 14, 2014

Related U.S. Application Data
(60) Provisional application No. 61/799,097, filed on Mar. 15, 2013.

(51) Int. Cl. F41H 5/04; A62B 23/02; F41H 5/02; F25B 21/02; F41H 1/02; F41H 1/04

(52) U.S. Cl. CPC F41H 5/0407; F41H 1/02; F41H 1/04; F41H 5/02; F41H 5/04; F41H 5/0471; F41H 5/0414; F25B 21/02; A62B 23/02; F25B 2321/02
USPC 89/36.02; 89/36.05; 62/3.6; 128/201.25

(57) ABSTRACT

Attacks from improvised explosive devices (IEDs) are one of the major causes of soldiers being killed in action (KIA) and wounded in action (WIA). Such improvised explosive devices can cause considerable damage, disability and death from a device as small as a cellular telephone, to several thousand pounds of explosive material, and linked military artillery munitions, capable of cutting armored vehicles in half, to completely destroying the vehicle and killing all occupants within.

A wide range of protective wear/gear or garments, have been designed to shield against a percentage of explosive blast effects of smaller less lethal improvised explosive devices and munitions, in an effort to reduce human casualties associated with explosive ordnance disposal. However, such protective wear/gear or garments have failed to keep pace with the evolution of improvised explosive devices, their destructive capabilities, and the technical sophistication of those responsible for their creation and fabrication.

Improvised explosive devices (IED), and Vehicle borne improvised explosive devices (VBIED), are increasingly being used to the determent of the explosive ordinance personnel sent out to respond and either disarm or destroy the explosive devices. Additionally, with the rise in relay or remote control detonation, the EOD technicians face the threats of pre-detonation approaching the device(s), or subsequent detonation to the EOD technician departing the disarmed primary threat only to have a secondary IED threat detonated fatally injuring or killing him. Approach and departure from purposely designed, manufactured, disguised and concealed IED threats and the methods of their deployment are increasing in their complication of designs, performance capabilities and modes of utilization to the extreme detriment of soldiers, law enforcement and EOD technician personnel.

These increasingly common events translate into a greater need for explosive ordnance disposal (EOD) technicians and a greater risk incurred by the EOD technicians employed by the military and law enforcement agencies.

In the past, the use of bomb disposal protective equipment has meant an overwhelming weight burden, restrictive internal movement space, minimum fragmentation velocity resistance, absence of ballistic resistant capabilities, the loss of dexterity and eye-hand coordination to the detriment of the render-safe mission though reduced flexibility and overheating.

The advent of newer materials with greater protective capabilities, flexibility, cooler to operate within, increased visibility through the helmet, and lighter weight, coupled with increased levels of protection, represents a significant improvement for EOD technician personnel, and explosive blast detonation defeat protection.

### CROSS-REFERENCE TO RELATED APPLICATION(S)

This application is a non-provisional patent application that claims the benefit of the filing date of, and priority to, U.S. Provisional Application No. 61/799,097, filed Mar. 15, 2013, the entirety of which is incorporated herein by reference.

### FIELD

The invention relates to protective wear. More specifically, the invention relates to an Explosive Ordinance Disposal (EOD) suit, designed to preclude over exposure related to overheating such as, heat prostration/exhaustion, dehydration, hypothermia; and to provide increased flexibility, lighter weight with substantially improved fragmentation, and shrapnel resistance; increased visibility; and added rifle defeating ballistic resistance performance capabilities.

### BACKGROUND

The proliferation of IEDs on the battlefield in both Iraq and Afghanistan has posed the most pervasive threat facing coalition forces in those theaters. The persistent effectiveness of this threat has influenced unit operations, U.S. policy, and public perception. IEDs are a weapon of choice and are likely to remain a major component of the Global War on Terrorism for the foreseeable future.

The definitive history of IEDs has not been extensively documented. However, many specific incidents in the last 100 years have been well documented. Recently, there has been a trend of increasing terrorist acts against the United States. These attacks have increased in their frequency, in their level of sophistication, and in their lethality. For example, some non-everyday IED occurring, news worthy reported incidents have been:

The Marine barracks in Beirut, Lebanon, was attacked with a truck bomb that killed 241 U.S. Marines in 1983.

This was followed by the bombing of Pan American Flight 103 over Lockerbie, Scotland, in 1988. (The plane carried passengers from 21 countries, but 189 of the 259 on board were Americans; the crash also killed 11 people on the ground.)

In the first terrorist attack on the World Trade Center in New York City in 1993, a truck bomb failed to cause the desired number of casualties but nevertheless demonstrated the ability to attack the U.S. homeland.

In 1996, another truck bomb killed 19 U.S. Soldiers and injured 372 at the Khobar Towers housing complex in Dhahran, Saudi Arabia.

The violence continued with the bombings of the United States embassies in Kenya and Tanzania in 1998 and the United States Ship (USS) Cole in the port of Aden, Yemen, in 2000.

On Sep. 11, 2001, a series of four coordinated terrorist attacks were launched by the Islamist terrorist group al-Qaeda upon the United States in New York City and the Washington, D.C. areas. 19 al-Qaeda terrorists hijacked four passenger jets, intending to fly them in suicide attacks into targeted buildings. Two of those planes, American Airlines Flight 11 and United Airlines Flight 175, were crashed into the North and South towers, respectively, of the World Trade Center complex in New York City. A third plane, American Airlines Flight 77, was crashed into the Pentagon. The fourth plane, United Airlines Flight 93, was targeted at the United States Capitol in Washington, D.C., but crashed into a field near Shanksville, Pa. after its passengers tried to overcome the hijackers. Almost 3,000 people died in the attacks, including all 227 civilians and 19 hijackers aboard the four planes.

With the development of sufficiently powerful, stable, and accessible explosives, a preferred weapon of a terrorist, is an IED or “bomb”. As a weapon, IEDs are extremely efficient, as they allow a person or group to strike with great destructive effect without injury to themselves, or the possibility of rapid identification. The sophistication of the device depends on the maker, and subsequently on the appropriate manner of utilization. They can range from being very simple, to very complex with booby traps, anti-handling devices, and sophisticated electronic initiation devices to prevent disarming. Generally, IEDs can be triggered in a variety of ways. A timer is common and can be set hours in advance. Remote-controlled detonators with a limited range allow the timing of a detonation exactly. The terrorist now has the choice of remaining in the area, or being hundreds of miles away when the IED detonates.

IEDs can be manufactured out of many household products (including fertilizer, sugar, phenol-aspirin, urea, hexamine, medical disinfectants, cleaning chemicals, and batteries, etc.), but most sophisticated bombs use a small amount of explosive to trigger a larger quantity of poorer grade explosive material. IEDs do not have to be large to be effective. Most IEDs are small and are directed at individual targets, such as military personnel or politicians. Often these are planted along a roadside and detonated as a vehicle passes. Larger devices can be placed in vehicles (VBIEDs) parked along the roadway or driven into the target by suicide bombers willing to give up their lives for the cause. Another VBIED is the bicycle, is often not paid too much attention to and is easily deployed in plain sight, and has killed as many as 50 persons in a single detonation utilizing the frame as the materials for fragmentation. The most fluently moving and most difficult to locate is the IED worn by an individual (PBIED), in which the individual houses the entire IED or the principle IED components and/or serves as the delivery or concealment means for detonation complete with the initiating device.

An IED (Improvised Explosive Device) is any explosive device designed and fabricated in an improvised manner, incorporating destructive, lethal, noxious, pyrotechnic, incendiary materials and chemicals combined or utilized with other constituent biological, radiological, or nuclear chemicals (CBRNE), designed to destroy, kill, incapacitate, disfigure, distract, harass, or destabilize. They may incorporate military munitions, but are normally devised from nonmilitary components and designed to destroy or incapacitate personnel or vehicles. IEDs may incorporate military or commercially-sourced explosives and often combine both types, or they may be made with homemade explosives (HME) in the absence of commercial/military explosives.

IEDs can be used to cause politically, and morally unacceptable casualties anywhere and at any time. However, they can be used at a particular time and/or place in order to deny U.S. or coalition military or law enforcement forces access to an area, deny them safe haven, disrupt logistics, or impede movement. They can also be used to assassinate key military, government, or civilian figures or to target a particular group or organization. Physical casualties caused by IEDs also create a psychological effect that can intimidate or coerce others.

Although virtually any person or type of conventional or paramilitary group may employ an IED, it is a proven and effective weapon for individuals, insurgents, terrorists, other non-state actors, organized or non-organized, paramilitary or military forces, national entity, or national alliance actors that are in opposition to the United States government actions or inactions or laws; its allies, or its multinational partners. In the case of IEDs, the enemy can be any individual, group, or organization that employs IEDs, regardless of their motivation (sociological demographics). Such groups may or may not be linked to a political state and are not limited by geographic boundaries. Their motivations are often ideological and do not share the same characteristics or centers of gravity as those found in a typical state versus state conflict.

An attacker/enemy who is not a peer competitor will avoid engaging U.S. and/or coalition forces in a head-to-head conventional fight. The enemy will not fight U.S. or coalition forces in the same manner as it would its peers or lesser forces in its region. Instead, it will have to resort to adaptive and improvised approaches in order to accomplish its goals against a U.S. or coalition force that overmatches it in conventional technology utilization or military power.

Asymmetry in warfare is not a new phenomenon, but given the relative capabilities of the United States military and law enforcement communities, as opposed to its potential opponents, it is increasingly likely that terrorists will seek adaptive, asymmetric approaches. They will seek to avoid or counter U.S. strengths without having to oppose them directly, while exploiting perceived U.S. weaknesses. In such cases, IEDs will become the weapons of choice.

Explosives are categorized as either high-order explosives (HE) or low-order explosives (LE). HE explosives produce a defining supersonic over-pressurization shock wave. Examples of HE include TNT, C-4, Semtex, nitroglycerin, dynamite, and ammonium nitrate fuel oil (ANFO). LE create a subsonic explosion and lack HE's over-pressurization shock wave. Examples of LE include pipe bombs, gunpowder, and most pure petroleum-based bombs such as Molotov cocktails or aircraft improvised as guided missiles. HE and LE create substantially different types of destruction and injury patterns.

HE explosives are also referred to as high brisance explosives. High brisance explosives are those that are effective at shattering casing materials and propelling fragments. LE explosives are also referred to as low brisance explosives.

Chemical reactions in the explosive materials vary and the speed of the reaction is vital to the build-up of a large amount of energy into a small volume. Reactions that proceed slowly allow energy that is released to be dissipated (this is a consideration involving the interaction of the shock wave with targets). A detonation/explosion will either create an overpressure shock wave, propel fragmentation and shrapnel outward, or both, dependent upon design. If the energy release is slow (low Brisance), the overpressure shock wave will be gradual and extended and the fragment velocity if any, low. These types of explosives can release a large amount of energy, but due to the relatively slow rate of reaction (deflagration), the energy is more useful as a propellant, where the expansion of gases is utilized to propel projectiles (gunpowder). Conversely, an extremely rapid and violent reaction (detonation) will be characterized by an extremely sharp (short duration, high pressure) shock wave and high fragment/shrapnel velocities. Brisance is a property of the material and the degree of confinement.

A detonation/explosion is caused by the rapid exothermic oxidation of a solid or liquid material into gaseous reaction products, resulting in a large energy release in the form of increased pressure and temperature within the explosive compound. That reaction and pressurization propagation process within the explosive is known as the detonation shock wave. In solids and liquids, detonation shock waves propagate from the center of ignition outward at supersonic speeds of 6 to 8.6 kilometers per second/19,684 to 28,246 feet per second (6.8 kilometers per second or 22,309.71 feet per second for encased TNT), whereas in gases detonation waves move at 1 to 3.5 kilometers per second/3,281 to 10,499 feet per second. For comparison, the speed of sound in air in normal atmospheric conditions is 340 meters per second/1,115 and in freshwater is 1,435 meters per second/4,708 feet per second.

The ratio of the wave speed, u, to the sound speed, c, is known as the Mach number, Ma=u/c. Blast waves propagate at supersonic speeds, Ma>1. The explosion reaction typically is completed within a few microseconds, converting the originally solid material into a highly pressurized gas. Typical explosives, such as C4, generate pressures of thousands of atmospheres (1 atm=101,325 N/m2/14.7 PSI) and temperatures of 2,000° to 4,000° K/3,140° to 6740° F.

These reaction gases expand violently, compressing and forcing out the surrounding air. A pressure induced shock wave, oftentimes referred to as “blast wave”, is formed, spreading in air radially outward. The shock wave consists of a microns-thin pressure wave, followed closely by the accelerated displaced air often referred to as “blast wind”. The blast wind is the resultant negative pressure, which sucks items back in towards the center, as the ambient pressure attempts to reach a normalized equilibrium based on the density altitude for the original ambient pressure. There is a dramatic increase in pressure across the shock wave. FIG. 1 shows a typical peak impulse overpressure and time history decay of the ideal shock wave based on an open arena hemispherical detonation.

Part of the explosive (chemical) energy is used to break up the explosive munitions' casing (the exterior metallic case of an artillery round, mortar, grenade, etc.), resulting in the generation of fragmentation, which are accelerated by the accelerated displaced air. These kinetic projectiles also move radially outward, but at speeds much slower than the advancing shock wave. See FIG. 2.

Simply defined, when an explosive charge detonates in air (hemispherical) the expanding gases push on the surrounding air, forcing out a shockwave—a sudden rise in pressure and other gas parameters to include temperature and density. The initial peak over pressure and the peak shock pressure at any given distance from the detonation vary proportionally with the charge size, and the distance from the epicenter of the detonation.

This is expressed by the following formula:

$$P ( t ) = P 0 + Ps [ 1 - ( \frac{t - {t}_{a}}{{T}_{s}} ) ] \cdot exp [ - b ( \frac{t - {t}_{a}}{{T}_{s}} ) ]$$

Where t is the time measured from the instant the shock wave arrives, Po is the ambient pressure, Ps is the peak overpressure, Tₛ is the duration of the positive phase, tₐ is the arrival time, and b is a positive constant called the waveform parameter that depends on the peak overpressure. Pmin is the minimum pressure reached. FIG. 2 shows the simplified pressure time history profile generated by an ideal blast wave at a point away from the center of the explosion. Before the shock wave reaches the given point, the pressure is equal to the ambient pressure Po. At arrival time tₐ, the pressure rises discontinuously to the peak value of Po+Ps. The pressure then decays to ambient pressure Po in total time tₐ+T (positive phase), drops to a partial vacuum pressure of value Po−Pmin (negative phase) due to the overexpansion of gases, and eventually returns to the ambient pressure Po.

Although the overpressure created by an explosive can be highly destructive, it decays exponentially as a function of time and distance. For example, the peak overpressure from an artillery round at a range of 4 feet is 364 pounds per square inch (psi). At a range of 16 feet, the peak overpressure is only 17 psi (5% of the overpressure at 4 feet).

FIG. 3 illustrates the pressure profile as a function of the radial distance from the explosion center at selected times. Note in FIG. 2 that as the gases continue to expand, the pressure drops, creating a relative vacuum at t=t₄ behind the shock wave.

Eventually the overpressure will decay to a point where a negative pressure (vacuum) below the ambient pressure will occur, and then increase again as the ambient pressure attempts to reach a normalized equilibrium based on the density altitude for the original ambient pressure. See FIG. 1.

For this reason, improvised explosive devices often are constructed to generate high-velocity fragments, or are filled with metallic objects (shrapnel), which are propelled during the detonation. Whether from the breakup of the munitions casing (fragmentation), or from objects embedded in the explosive (shrapnel), the objective is to increase the range and lethality of the explosive by generating secondary penetrating projectile injuries, or death through hemorrhage created by overwhelming amounts of penetrating wounds created by fragmentation or shrapnel which have jagged configuration, extremely sharp edges, and being extremely hot from the exothermic detonation process. Secondary missile fragmentation in the form of ground debris, rocks, sand, soil or other objects lying on, or buried in the ground are also violently picked up by the detonation and blast wind creating penetrating and/or blunt trauma injuries.

In addition to fragment and shrapnel projectiles, the lethality of an explosive sometimes is enhanced by the addition of chemical and flammable substances (incendiary). The effectiveness of these additives varies widely, but they can produce an increase in the number and severity of burn wounds.

The functional purpose of any incendiary material is to ignite an extremely high heat (approximately 2,000 to 4,000° F.) burning fire, utilizing thermite, and other combustible metals; or combustible hydrocarbons, pinpointed by specific munitions or more diverse in amount of target area utilizing such methods as an accelerated massive airborne fireball (thermobaric) across as wide a swath of the target area as possible thereby increasing the ability to ignite combustible materials, or fluids; or to draw the oxygen out of the immediate area providing for a killing effect caused primarily by suffocation (Napalm) and subsequent hydrocarbon based burning fire.

A detonation of an explosive device produces four precursory effects that emanate directly from the epicenter of the detonation. They are:

The fireball, which includes flame and the exothermic heat transfer created by the explosive with temperatures up to 9,000° F., depending upon additives.

The fragmentation and/or shrapnel traveling at burst velocities from 3,000 to in excess of 4,900 feet per second.

The explosive blast overpressure shock wave propagation, with possible overpressures in excess of 65 PSI.

The negative pressure vacuum phase with a possible negative vacuum pressure of 13 PSI.

FIG. 4 defines the maximum effective radius for primary and secondary blast injuries of an open-field 155-mm mortar shell explosion with 200 lbs. (100 kg) of trinitrotoluene equivalent explosive (TNT); potential injury from fragmentation can exceed 1,800 feet from the epicenter of the detonation. The pressure/time history plot is depicted by the overlaid black line.

To aid in defining the detonation overpressure shock wave advance displacement velocities, peak overpressure equivalencies equated to wind speed would be: 1 PSI=38 MPH, 2 PSI=70 MPH, 3 PSI=102 MPH, 5 PSI=163 MPH, 10 PSI=294 MPH, and 20 PSI=502 MPH.

Injuries:

Common explosive blast injuries include pulmonary barotrauma, brain injury, abdominal hemorrhages, ocular injury, tympanic membrane rupture and middle ear damage, crush injuries, traumatic amputations, and burns. Blast injuries are the result of any of four basic injury inducing mechanisms termed as primary, secondary, tertiary, and quaternary.

Victims may have complex injury patterns involving multiple organ systems as a result of a combination of some, or all of these blast injury mechanisms.

Primary

Blast-related injuries are characterized by anatomical and physiological changes that result from the overpressure shock wave violently impacting the body's surface and tissues, and affect primarily gas-containing structures. When individuals are located in the immediate proximity or epicenter of an explosive at the time of detonation, gaping lacerations of the skin and the internal organs and severe mangling of body parts generally occur, or the victims' bodies may be even totally disrupted. Traumatic amputation of limbs is a frequent occurrence, especially in those who were located in the immediate proximity of the explosive at the time of detonation. As a direct effect of the super-heated detonation overpressure shock wave that emanates powerful shearing forces which impact in a direction perpendicular to the bones in the body, create fractures of the long bone shafts. Limb flailing caused by the detonation overpressure shock wave, then completes the amputation by disrupting the soft tissue.

Apart from whole body disruption and the amputation of limbs, the detonation overpressure shock wave exposure almost exclusively affects all gas-containing organs. This overpressure shock wave exposure forces impinging pressure stresses at air/fluid interfaces, gas-containing organs such as the lungs, middle ear, and the gastrointestinal tract. The resulting injuries are generally either: blast lung injury, tympanic membrane rupture, and bowel contusion and/or bowel perforation in the absence of penetrating abdominal wall wounds.

Primary blast injuries are estimated to contribute to 47 to 57% of injuries in survivors and to 86% of fatal injuries.

Secondary

Blast-related injuries result from flying debris (e.g., rocks, glass, concrete, metal, wood, etc.) and IED fragmentation and/or shrapnel striking the victim, resulting in penetrating or less commonly encountered blunt trauma from non-penetrating impacts. Such injuries generally are a combination of bruises, puncture abrasions, puncture lacerations, and high velocity projectile penetrating wounds, equal to or greater than rifle projectile destruction.

Tertiary

Blast-related injuries result from the victim being violently thrown by the accelerated impacting overpressure shock wave (forced super-heated air flow), which can lead to fractures, traumatic amputations, closed and open brain injuries, or other blunt or penetrating trauma resulting from the body's abruptly decelerated impact into or onto objects.

Quaternary

Blast-related injuries are all explosion-related injuries, illnesses, or diseases not primarily due to the primary, secondary, or tertiary mechanisms, and include exacerbation or complications of existing conditions. Examples include thermal or chemical burns, radiation exposure, or inhalation injury from exposure to dust or toxic gases, and crush injuries or implications from asphyxia due to air contamination, or debris lying upon the victim with a crushing pressure, etc.

Additionally, the victims may receive significant skin burns inflicted by the detonations “explosions”. The severity of a burn is directly related to the temperature rise within the skin and the duration of this rise. One has to differentiate between primary and secondary thermal injuries.

Primary Thermal

Although the term detonation overpressure shock wave refers to the intense over-pressurization impulse created by a detonating explosive, this phenomenon can also contain super-heated air flow (heat radiation) that is generated by the detonation/explosion exothermic process. It is characteristic of detonations/explosions that flash burns inflicted by this super-heated overpressure shock wave are usually limited to exposed (undressed) areas of the victim's body since clothing usually provides good protection from flash burns (primary thermal injuries). These primary thermal injuries are generally more superficial than those seen as a result of secondary thermal injuries.

Secondary Thermal

Burns occupying large surface areas and affecting those body areas covered by clothing prior to the detonation/explosion imply that either the heat was of such intensity that the victim's clothing caught fire (conflagration), or that the victim was in close proximity to the epicenter of the detonation, or incendiary compounds/compositions were added, or that the location where the detonation took place caught fire. These burns are designated as secondary thermal injuries and are more severe than primary thermal injuries, and can cause fatalities.

All of the related of injuries from explosive detonations to the body in the distribution wound impact chart below, are directly relative to the percentage of unprotected or inadequately protected body surface area. This does not account for impacting fragmentation and/or shrapnel impacts defeated by body armor or other barriers to impact with the individual's body. However, the low percentage of wounds in the thorax and abdomen regions can be seen in the data presented.

Distribution of wounds by body region of military
personnel from IED detonations in 2008. (1,566
soldiers with 6,609 penetration wounds)

| | % of Body Surface Area | % Wounds per Body Area |
|---|---|---|
| Head/Neck | 12 | 30 |
| Thorax | 16 | 6 |
| Abdomen | 11 | 9 |
| Extremities | 61 | 55 |

Additionally, explosive detonations within an enclosed space will result in a substantially higher immediate mortality rate and with increased critical injuries.

The compounding issues of confined spaces are due to the detonation overpressure shock wave rebounds off of walls, (creating a complex shock wave field), or other surfaces that are not destroyed from the detonation, exasperating multiple rebounding shock wave impacts imparting damage multiple times and over a larger surface area of the body as compared to open air spaces.

Moreover, fragmentation and/or shrapnel will also rebound off of walls and/or objects, and if they did not strike the individual the first time, they have a substantially enhanced percentage of inflicting increased numbers of multiple impacting projectile penetrations.

If the explosion occurs above the ground, when the expanding blast wave strikes the surface of the earth, it is reflected off the ground to form a second shock wave traveling behind the first. This reflected wave travels faster than the first, or incident, shock wave since it is traveling through air already moving at high speed due to the passage of the incident wave. The reflected blast wave merges with the incident shock wave to form a single wave, known as the Mach Stem. The overpressure at the front of the Mach wave is generally about twice as great as that at the direct blast wave front.

FIG. 5 is an example of a complex overpressure pattern in an enclosed area. As can be seen, there are two major overpressure peaks as the initial overpressure shock wave is reflected off walls, with multiple slower decaying rebounding waves through 0.037 seconds.

| Overpressure | | Types of Injury or Damage |
|---|---|---|
| 0.5-1.0 | PSIG | Breakage of glass windows, doors, etc. |
| →1.0 | PSIG | Knock down people. |
| 1.0-2.0 | PSIG | Damage to corrugated panels/wood siding. |
| 2.0-3.0 | PSIG | Collapse of non-reinforced cinder block walls. |
| 3.0-5.0 | PSIG | Collapse of reinforced cinder block walls. |
| 5.0-6.0 | PSIG | Push over wooden telephone poles. |
| →5.0 | PSIG | Rupture ear drums. |
| →15.0 | PSIG | Lung damage. Collapse of 8″ thick solid pour concrete |
| | | walls. |
| →35.0 | PSIG | Threshold for fatalities. |
| →50.0 | PSIG | Approximately 50% fatality rate. |
| →65.0 | PSIG | Approximately 99% fatality rate. Destruction to various |
| | | bunker style structures. |

Prior art systems do not provide the level of protection necessary to protect soldiers against today's explosive and ballistic threats. FIG. 11-FIG. 18 illustrates one embodiment of a prior art garment. As can be seen from the various aspects illustrates in FIGS. 11-18, the prior art garment is a suit including a jacket, pants, outer vest, neck portion and helmet portion, each of which are separate pieces that must be put on, one at a time, by the wearer. In particular, the pants include a suspender system and zippers for opening and closing the leg portions. Once the user places their legs in the leg portions and zips the legs, they can secure the pants by positioning the suspenders over the shoulders. It is noted that the pants are open in the groin region and require a separate diaper portion that must be placed over the pants and groin area to cover this region. Once the pants are in place, the user puts on the jacket. The jackets is a two piece jacket which includes a base jacket portion which covers the torso and arms and a separate yoke that is placed over the base jacket portion to cover a front and back portion of the torso. The neck and helmet portion are also separately placed on the user. Since each of the pieces are separate, there are several gaps and openings through which a wearers safety may be compromised.

### SUMMARY

A unitized, Explosive Ordinance Disposal (EOD) suit comprised of an inner rifle defeating flexible ballistic and fragmentation resistant body armor vest with coverage designed to wrap completely around the torso and abdomen, and designed to be coupled with an outer garment (suit) by way of a quick release system, providing a complete armor wrap around the body from the base of the foot up to the helmet secured to the head and outward to the wrists. This completed unitized suit system to comprise of multiple tiered levels of protection for high power rifle threats up to and including the .338 Lapua threat, detonation overpressure shock wave, mild steel and high hardness steel fragmentation and shrapnel up to and including 25 mm dimensioned and massed projectiles. The suit is to have an improved positive pressure, cooled circulatory air system for the internal wearer environment.

Coupled with the suit is an improved helmet with reduced weight, increased visibility, low profile resistance to reflect the overpressure shock wave and acceleration of the head under that loading, improved cooling and defogging of the helmet with a reduced or eliminated audible noise output from circulating fans, thereby increasing the hearing capability of the EOD technician in communications, reinforced, lighter, and thinner face shield coupled with greater fragmentation resistance.

### BRIEF DESCRIPTION OF THE DRAWINGS

The embodiments disclosed herein are illustrated by way of example and not by way of limitation in the figures of the accompanying drawings in which like references indicate similar elements. It should be noted that references to “an” or “one” embodiment in this disclosure are not necessarily to the same embodiment, and they mean at least one.

FIG. 1 shows a typical peak impulse overpressure and time history decay of the ideal shock wave based on an open arena hemispherical detonation.

FIG. 2 shows a typical peak impulse overpressure and time history decay of the ideal shock wave based on an open arena hemispherical detonation, and their respective phase durations.

FIG. 3 illustrates the pressure profile as a function of the radial distance from the explosion center at selected times.

FIG. 4 illustrates the maximum effective radius for primary and secondary blast injuries of an open-field 155-mm mortar shell explosion with 200 lbs of TNT.

FIG. 5 illustrates a complex overpressure pattern in an enclosed area.

FIG. 6 illustrates one embodiment of a TE Module and the temperature differential along it.

FIG. 7 illustrates an exploded view of one embodiment of a TE module.

FIG. 8 illustrates how pulse-width modulation functions.

FIG. 9 illustrates various embodiments of fragment simulating projectiles (FSP).

FIG. 10 illustrates the fragmentation characteristics of common artillery projectiles.

FIG. 11 is a graph illustrating burst distance and velocity as a function of range for the 152 mm OF540 and the 155 mm M107 Artillery Projectiles when used as an IED.

FIG. 12 illustrates one embodiment of a prior art garment.

FIG. 13 illustrates one embodiment of a prior art garment.

FIG. 14 illustrates one embodiment of a prior art garment.

FIG. 15 illustrates one embodiment of a prior art garment.

FIG. 16 illustrates one embodiment of a prior art garment.

FIG. 17 illustrates one embodiment of a prior art garment.

FIG. 18 illustrates one embodiment of a prior art garment.

FIG. 20 illustrates a front view of one embodiment of a protective garment without collar.

FIG. 21 illustrates a back view of the protective garment without collar of FIG. 20.

FIG. 22 illustrates a side view of the protective garment without collar of FIG. 20.

FIG. 23 illustrates a magnified view of a reinforced gusseted arm region of the protective garment of FIG. 20.

FIG. 24 illustrates a front view of an inner vest of the protective garment of FIG. 20.

FIG. 25 illustrates a side view of the inner vest of the protective garment of FIG. 20.

FIG. 26 illustrates a magnified view of a reinforced gusseted groin region of the protective garment of FIG. 20.

FIG. 27 illustrates a front view of a leg region with the opened area for the Emergency Quick Release mechanism of the protective garment of FIG. 20.

FIG. 28 illustrates a front view of a reinforced knee region of the protective garment of FIG. 20.

FIG. 29 illustrates a front view of a reinforced elbow region of the protective garment of FIG. 20.

### DETAILED DESCRIPTION

In this section we shall explain several preferred embodiments with reference to the appended drawings. Whenever the shapes, relative positions and other aspects of the parts described in the embodiments are not clearly defined, the scope of the embodiments is not limited only to the parts shown, which are meant merely for the purpose of illustration. Also, while numerous details are set forth, it is understood that some embodiments may be practiced without these details. In other instances, well-known structures and techniques have not been shown in detail so as not to obscure the understanding of this description.

To provide effective reduction of injuries actually received in IED explosive detonation/blast incidents, the types of injuries, explosives, fragmentation, shrapnel, and modes of utilization need to be evaluated against currently deployed IEDs and their effective performance capabilities. This process will eliminate the asymmetrical threat capability gaps currently avoided in the EOD role designed protective suits of today.

The base component weights of the suits, helmets, and the wide visor projected area are currently in excess of from approximately 68 to 75 pounds without any liquid cooling circulatory options, CO₂ cooling cartridges, standard battery load requirement and any extended battery options, hydration equipment, communications equipment, tools, etc.

For blunt trauma and projectile penetration protection against IED detonations, there is a significant tradeoff between ergonomics and protection. For instance, a larger mass helmet may provide greater protection against blunt force trauma, but may be more difficult to wear thus having a detrimental impact on the render safe operation. Another often overlooked and significant suit design affect, is the inability of the suit and helmet to remove exothermic heat created by the body, the exterior environmental temperatures, and the heating of the suit itself through solar heat radiation. Excessive heat on the body creates a critical drop in focus and concentration necessary to diffuse a bomb or complete other critical close quarters or finite motor skill movements and dexterity, and does induce fatigue and psychological factors relating to an enclosed, heavy and constrictive suit creating a claustrophobic and anxiety inducing environment for the wearer.

Reducing or eliminating the diminished EOD technician's tactical effectiveness is of paramount importance.

Such tradeoffs underscore the value of a complete assessment of bomb suit function as a system that includes the operator as a key component. This should include an assessment of the environmental ergonomics of the suit, in addition to the normal flexural and mobility ergonomics; protection against fragments and projectiles; and protection against blunt trauma.

Head Protection

As shown in epidemiology data, fatalities from head injuries are very significant in IED blasts. These injuries may be caused by direct blast impingement on the head or by blunt trauma from impingement of the protective gear.

The acceleration of a head under blast pressure loading is directly related to the frontal projected area of the head or helmet, and acceleration under an applied external force is inversely related to the mass of the head/helmet.

This correlation increases substantially with increasing charge size. Larger helmet/visor frontal areas tend to increase the risk of head injury from IED blasts from increased accelerations due to increased surface area exposure perpendicular to the blast flow. Additionally, greater helmet mass tends to decrease the risk of head injury by decreasing the acceleration of the head/helmet/visor system. This implies that either decreasing the visor area or increasing the mass of the helmet visor system or some combination of both increases protection from blunt trauma to the head. There is, however, an obvious tradeoff for the protective value of added helmet mass.

Increasing the helmet mass without regard for ergonomic factors of wearability and comfort may result in limited usage of the head protection, and additional stresses on the neck.

In addition, there is a tradeoff for the protective value of smaller visors/helmets. Decreasing visor/helmet size may make the wearer more vulnerable to penetrating fragments, and may adversely affect helmet fit, percentage of peripheral vision, and impact protection.

However, the additional mass of the helmet increases the inertial resistance of the head/helmet system, reducing the acceleration, delaying and reducing the peak force applied to the neck. Other variations may result from the distribution of the projected area of the helmet and face shield. The higher the projected area is on the head, the farther the resultant force of the blast is from the neck, thus creating a longer moment arm for the loading to act. However, as the force on the neck is the time-delayed result of force transmitted from the thorax and the head, it seems unlikely that neck injuries will be the dominant injury in protected EOD suit users, if an improved suspension/restraint mechanism is built into the suit in support such applied energy distribution coupled with increased lateral head mobility.

Barring local damage to the neck itself, the dynamic impulse in the neck must be transmitted through the relative motion of the head and the chest. This transmission of force is relatively slow compared to the impact of the blast wave. Therefore, neck injuries in blast are similar in rate to impact neck injuries that have been studied in automobile safety and other contexts, and where suspension/restraint mechanisms have reduced or precluded injury.

The helmet is designed to have a reduced frontal surface profile thereby, providing for a reduced overpressure shock transfer within the helmet as compared to current designs. Additionally, the helmet will include improved air circulation channels that aid in precluding back pressure to the forced cooled air circulating not only to the inside of the visor, but to the sides of the head, the nape of the neck and the crown of the head. The lower frontal chin region will have a formed overpressure redirecting rib providing a mechanism to redirect the overpressure shock wave in a manner that reflects if off of the front of the helmet while pushing down on the lower front chin section aiding in reducing the frontal head acceleration rate. The helmet will include a reinforced face shield imbed anchoring design to preclude face shield/visor pull-out during the overpressure incident shock wave phase. The visor will provide a lighter weight transparent design with increased fragmentation/shrapnel resistance. In one embodiment, the visor will utilize amorphous ceramic ballistic/fragmentation resistant transparent ceramic interface enhancement layer between the polymer outer layer and the internal anti-spall layer. The visor will incorporate an ambidextrous single point pull-forward self-locking latch to open the visor located in the lower frontal chin protection region of the helmet as opposed to the single side push-in style non-ambidextrous latch utilized on the current helmet designs. The visor will provide for full peripheral vision and increased vertical vision over current systems.

The internal harness assembly with its improved chin strap suspension and improved ear cups will provide increased adjustability, communications, and provide addition resistance to the overpressure shock wave and the transfer of pressure to the inner ear, thereby precluding tympanic membrane rupture.

The top of the oversuit will incorporate a high density light weight dynamic impulse neck restraint to catch the rear of the helmet, precluding excessive rearward transmitted motion of the head during the overpressure shock wave.

The helmet will be constructed from a titanium/polymer composite that is lighter and defeats a greater diversity of fragmentation and shrapnel threats. The inner shell is to be comprised of an energy absorptive layer utilizing a resilient high energy impact gel.

Various types of light weight resiliently compressible energy absorbing materials can be utilized in the backing of the disc materials such as elastomer foams, latex rubbers, synthetic polymers, polyurethane foams, EVA foams, PE foams, neoprene, thermoplastic elastomers and thermoplastic polyesters, EP rubber, silicone rubbers, EPDM rubbers, and closed cell foams. These would have a Shore 00 hardness from approximately 12 to 50, utilizing the ASTM D2240 test method. An overall density per cubic foot of approximately 25 to 65 utilizing the ASTM D792-00 test method. A resilience percentage of approximately 10 to 13 utilizing the ASTM D2632 test method. Such materials can be used independently or in a dual-density configuration.

Another type of energy absorbing light weight material would be shear thickening silicone dilatants, fluids or putty's added to textile components or manufactured into a self-supporting elastomeric matrix with or without particulate reinforcement additives such as fibrous fillers, plasticisers, extenders, lubricants, and whisker or tubular fillers are also capable in the backing of the disc materials. They work somewhat differently in that they will exhibit a resistive load under deformation or high or elevated strain rates which will increase with the rate of deformation due to the impact. These types of shear thickening materials actually have viscously low flow rates of strain deformation until an elevated strain rate increases the viscosity where they become substantially stiff or rigid to and inelastic under to attenuate the energy. These materials are typically in two forms.

One embodiment is in the form of either a putty-like dilatant in an unsuspended or non-self-supporting nature. In this configuration such putty like dilatants need to be contained within an envelope due to their non-supporting nature. This is usually in the form of a plastic or polymer containment bag, designed with multiple seamed cells or “baglets” to preclude flowing into one region of a continuous single sectioned bag.

Another dilatant embodiment would be in the form of a solid closed cell foam matrix such that this composite is resiliently compressible. In this form the energy absorbing capabilities are somewhat reduced from the prior form due to the matrix compositional additives. However, this form can be configured to dimensions without fear of rupture or damage by puncture.

It is a prerequisite that any such composite materials utilized in the attenuation and absorption of energy that they are resistant to a permanent set condition under the various types of loading such as compression, tension, shear or a combination of any of these. The desired effect would be to have a suitable lightweight resilient energy absorbing material that will have a quick recovery from compression within a few seconds.

The configurations of the above light weight resiliently compressible energy absorbing and attenuating materials can be in a full unit of material such as a fully dimensioned (for the specific area to be protected) pad, or laid out into hexagonal or round side-by-side points or “rounds/nodes”, or in multiple seamed cells or “baglets” depending upon the material that are not directly connected such as in a honeycomb configuration or grid. Cells can take the shape of hexagonal, round, square, triangular or other dimensioned shapes as necessary to provide for protection and yet allow for the flexibility of the system.

Suit Protection

In order to successfully render explosive devices safe, the EOD technician must be able to accomplish several tasks efficiently and safely. These may include but not be limited to:
Walking up to several hundred meters during the approach from a safe area and return to the safe area as many times as called for by the situation.
Climbing over barriers and negotiating obstacles such as doorways, stairs, guardrails, curbing, etc., and negotiating varied terrain, both indoors and outdoors.
Carrying necessary tools and equipment.
Set-up of equipment at the scene, including x-ray apparatus and disrupter.
Accessing small or difficult-to-reach areas such as those found under or inside vehicles.
Manipulation of various tools and items such as ropes, pulleys, clips, carabineers, and shock tubes.
Bending down onto one or two knees.
Bending over to reach down and pick up or lay down objects.

The suit must also allow the user to see well enough to complete these tasks, and to do so with as little fatigue from weight, bulk, and heat retention as possible. Successful EOD operations will be increasingly compromised if these tasks cannot be fully accomplished.

Current EOD suits have limited asymmetrical protection for the technician, primarily focusing on the front and limited lateral protection from the detonation overpressure shock wave and small lightweight penetrating projectiles.

Detonation overpressure shock wave pressure behind and to the sides of suits are generally complex, and identification of the duration of the pressure wave is not as straightforward as with an ideal incident shock wave. However, reducing or eliminating appropriate protection as is common in today's suits to reduce weight, reduces the level of protection to the technician within the suit. Positive overpressure does not act only upon the frontal surface of the suit. It acts on all sides in a multitude of axis, creating a 360° compression on the body. Non-protected areas can actually receive increased amounts of overpressure points, leading to increased body displacement and trauma.

The largest simulated IED positive overpressure shock wave testing of bomb disposal suits currently is too small to explore the upper suit limits of potentially survivable IEDs. Trinitrotoluene (TNT) has always been the standard for explosives and explosive damage, but with the development of improved HE explosives and energetic materials required to provide the necessary brisance to create the fissile prerequisite to fragment the projectile casing, this standard has become cumbersome and somewhat obsolete. Traditionally, explosives are characterized by a “TNT equivalence” value based on the energy released in a detonation, but this value is substantially insufficient. Different explosives have different energy release rates associated with their detonation, and these rate variations produce different explosion characteristics. Shock wave propagation speed is the salient result of a detonation, and it changes from one explosive to another depending on detonation properties and rates.

Additionally the simulated fragment penetration performance criteria is lacking as compared to deployed threats actually faced by the EOD technicians today. Again, it is a primary front of the vest design, requiring the EOD technician to back up, with no visibility or guarantee of secure footing, initially to depart an IED, so as to provide the maximum amount of protection until a designated stand-off distance is attained, before turning around. In an asymmetrical wartime environment for the military EOD technician, that leaves a multitude of unprotected areas exposed, especially with the increased use of multiple IEDs to draw-in technicians thereby trapping them between multiple IED threats. Additionally, military EOD technicians face rifle penetration threats which the current designs do not account for.

Since explosions in close proximity to the epicenter of the detonation may simultaneously cause traumatic amputations to multiple extremities and penetrating trauma to the torso, enhanced protection in these regions is necessary to reduce or preclude these massive injuries. The suit is additionally designed with multiple contingent tourniquet provisions located in either four or eight areas around the extremities. In the upper extremities there is one just below the shoulder in the upper bicep and tricep muscle area, and in another embodiment one just below the elbow above the flexor and extensor muscle area for each arm. In the lower extremities there is one running in a diagonal direction through the groin musculature region in the upper leg below the pelvis, and in another embodiment one just below the knee and above the major musculature region of the lower leg.

Patients with traumatic amputations may suffer significant but not quantifiable blood loss in the field prior to placement of a tourniquet and may arrive at a trauma center for treatment and recovery. However, having the torso and abdomen region perforated with penetrating fragmentation and/or shrapnel creates a higher mortality risk due to ongoing hemorrhage from numerous projectile penetrations resulting in substantial blood loss. In this specific region one cannot apply a tourniquet, and compression bandages have minimal effect at reducing the blood loss internally. Therefore, it is vitally important to have the appropriate levels of protection to preclude projectile penetration into the torso and abdomen regions, thereby increasing the chances of survival for the EOD technician subsequent to a close proximity detonation.

The suit is designed as a two component system designed to be coupled into a unitized system configuration. The first component is a ceramic composite “full torso” coverage vest, and the second component is a exterior over-suit component. The first component would be the full torso and abdomen body ceramic composite armor coverage component. This will have the option to meet the ballistic and fragmentation threats, as tested in one embodiment and listed in appendix A, and in another embodiment the ballistic and fragmentation threats, as tested in appendix B. This coverage provides frontal protection from the abdomen 2 inches below the navel area up to the suprasternal notch, and within 2″ into the upper most arm pit region, and wrapping to the rear with an overlapping joint 2″ past the medial line. The rear protection is from the C-7 vertebrae downward to the hip region of the pelvis just above the location where the external oblique muscles connect to the pelvis, and wrap around to the medial location where the front panel overlaps the rear panel. An additional lumbar support platform supports the vest and over-suit component thereby transferring all of the weight onto the hips, precluding any compressible weight transfer to the lower lumbar section of the spine.

In the regions of the over-suit component the titanium composite armor will meet the ballistic and fragmentation threats, as tested in one embodiment and listed in appendix C. This coverage covers the entire over-suit coverage including the over-the-boot region encompassing the upper foot and the both inside and outside side of the ankles, and the entire range of the arms down to the wrist. The appendix C coverage is additionally being designed for an over-glove component that protects from 2″ above the wrist down to 1″ past the metacarpophalengeal joint, (knuckle region) of the hand.

There is on the outside of the over-suit component attachment provisions utilizing a Molle webbing attachment system with modified quick release clips for three (3) optional coverage configurations that meets the ballistic and fragmentation threats, as tested and listed in appendix A and B.
1. This optional coverage is designed for the upper extremities providing coverage downward from the upper deltoid shoulder region to approximately 2″ below the elbow.
2. This optional coverage is also designed for the lower extremities providing coverage from the upper thigh and groin region down to 4″ below the knee region.
3. This optional coverage is designed to overlap the lower section of the first component by 2″ and to the outside of the hip/pelvic platform down to 1″ below the lowest area of the groin crotch region between the upper thighs.

Additionally, the over-suit has a fully attached collar without seam gaps in protection as current suits have, which surrounds the neck region to approximately 2″ above the base of the helmet from the sides and back, and with a yoke component for the frontal region upwards to just below the helmet with the ballistic and fragmentation threats, as tested and listed in appendix C, and an option to upgrade into the ballistic and fragmentation threats, as tested and listed in appendix A and B.

The suit is equipped with full Molle webbing attachment provisions on the front of the over-suit to attach a tool kit with a quick release doffing system.

There is an optional internal 100 ounce maximum hydration system pouch on the over-suit should the technician require it for long duration missions. The over-suit is to have a two “man down” drag bars on the rear of the over-suit and one on the internal vest component as a contingent back-up. Each of these will support over 400 pounds of pull without tearing off of the over-suit. This allows for full dead weight dragging of an unconscious EOD technician in the case of disability of severe injury to a safe location for medical treatment and/or transportation. The over-suit will have built into the rear portion near the neck collar a reinforced helmet restraint to aid in the reduction of any rearward acceleration movement, by catching and restraining the rear of the helmet with the channel of this helmet restraint.

Built into the oversuit there will no less than one and no more that two full ground dragging copper static discharge strips with a direct suit and direct contact to the technician through a single or double leg attachment point.

The suit will have an emergency quick release system that provides for access into the suit through the front or rear opening designs, and one to each of the outside medial lines of each arm and leg.

The over-suit will have built into the rear portion near the neck collar a reinforced helmet restraint to aid in the reduction of any rearward acceleration movement, by catching and restraining the rear of the helmet with the channel of this helmet restraint.

Built into the oversuit there will no less than one and no more than two full ground dragging copper static discharge strips with a direct suit and direct contact to the technician through a single or double leg attachment point.

The suit will have an emergency quick release system that provides for access into the suit through the front or rear opening designs, and one to each of the outside medial lines of each arm and leg.

In one embodiment, an air cooling re-circulation system for the suit and helmet is designed around the use of a dual piezoelectric cooling jet system (DCJ), manufactured by General Electric, as compared to the current use of comparable volume fans. This technology provides for increased air circulation volume flow; utilizes half of the energy requirements providing longer battery power life; and are virtually inaudible to the ear as compared to current fan technology. Having the ability to hear without fan noise in the background will aid the EOD technician considerably, and allow for increased concentration and radio communication. The DCJ units behave as micro-fluidic bellows that provide high-velocity jets of air. The turbulent air flow increases the heat transfer rate to more than ten times that on natural convection. The circulation flow will be transferred by ducting channels contained within the helmet interior design.

In one embodiment, an cooling re-circulation system for the suit and helmet is designed around the use of multiple ThinSink™ forced convection units (miniturized fan cooling technology), manufactured by Novel Concepts, as compared to the current use of larger comparable volume fans. This technology will also provide for increased air circulation volume flow; utilizing half of the energy requirements, approximately 0.031 watts of power consumption at 6,000 rpm, providing longer battery power life; and have a substantial decrease in audible sound dBA to the ear, as compared to the current utilized fan technology for EOD suits. Having the ability to hear without fan noise in the background will aid the EOD technician considerably, and allow for increased concentration and radio communication. The Thinsink™ provides for a 2,400% improvement in volumetric cooling efficiency, over comparable fan systems, and that efficiency is achieved by rotating (via motor) a thin totoid (circular fan disc), which generates an axial to radial fluid air flow field, with a nominal thickness of 0.029″ inch/0.75 mm. This added air circulation flow is attributed in part to the entraining remote air created by Bernoulli effect, where an inviscid flow (no viscosity) increases in speed occurs simultaneously with a decrease in pressure or a decrease in a fluids potential energy, (energy stored in a system forcefully interacting with physical entities). Newton's second law also elucidates in another manner where if a small volume of fluid is flowing horizontally from a region of high pressure to a region of low pressure, then there is an increase amount of pressure behind that front. This provides a NET force on the volume accelerating it along the streamline.

Each of these two air re-circulating systems will require a newly designed novel bifurcated venturi delivery system designed around the low flow rates with the modified design of a modified Bernoulli tube thereby, increasing the flow velocity through a lower cross sectional air flow splitter, allowing for segregation of refrigerated air flow to the helmet and the suit while capturing reserve quantities of the initial refrigerated air flow for a re-chilled closed circuit design system aiding in the re-chilling, drying and increased forced recirculation of previously chilled air within the helmet and suit. The balance will be forcefully discharged through the neck, wrist, and ankle regions of the helmet and suit respectively.

A two or three velocity flow rate control will allow the technician to increase or decrease the chilled air flow throughout the helmet and suit.

In one embodiment, the cooling or air chilling is designed through a modified thermoelectric device (TE), designed for cooling air to be circulated. This type of unit is commonly referred to as a thermoelectric cooling unit (TEC). The thermoelectric cooling unit takes a small electrical current which passes through the contacts of two dissimilar conductors in a circuit, a temperature differential appears between them. This is the basis of thermoelectricity and is applied actively in the thermoelectric cooling modules.

FIG. 6 is a simplified illustration of the TE Module and the temperature differential along it.

A TEC will typically produce a maximum temperature difference of 158° F./70° C. between the hot and cold sides. The more heat that is to be transferred through a TEC, the less efficient it operates effectively, as the TEC needs to dissipate both the heat being transferred as well as the heat it generates itself from its own power consumption. The amount of heat can be absorbed in proportional to the current and time of draw. This process is defined and express as the Peltier coefficient by the following formula:

W═PIt

### Where:

P is the Peltier coefficient
I is the current
T is the time.

The Peltier coefficient is dependent on temperature and the materials the TEC is manufactured from. The amount of heat absorbed or released at the thermocouple junction is directly proportional to the current and its duration. P is the Peltier coefficient (the amount of heat evolved or absorbed at the junction of a thermocouple when a current of 1 ampere passes through it for 1 second. This coefficeient is dependent upon the various materials from which the thermocouple is manufactured. This effectiveness is called the “figure of merit”. The effectiveness of a thermocouple is given a “figure of merit” designated as ZT. It is calculated as:

ZT=S²T/r·k

### Where:

S is the Seebeck coefficient, T is the temperature, r is the electrical resistance, and is the thermal conductivity. S, r and k will all vary depending upon the constituent pellet materials.
Thermoelectric junctions are approximately 4 times less efficient in refrigeration applications than conventional means. TEC's provide approximately 10-15% the efficiency of the ideal Carnot cycle refrigeration system or compared with 40-60% as achieved by conventional compression cycle systems such as the Rankine compression/expansion systems. Additionally, there is no requirements for the use of chlorofluorocarbons. Therefore, the system alone will not provide the requisite cooling performance capabilities without the newly designed novel bifurcated delivery system. However the TEC does provide for use in environments where low maintenance, compact dimensions, lack of orientation sensitivity, lack of moving parts, noise reduction, flexible design dimensions, long life, light weight, and lack of refrigerant chemicals would be a prerequisite. TEC cooler performance is a function of ambient temperature, hot and cold side heat exchanger performance, thermal load, the thermopile geometry, and the electrical parameters.

A TE module is a device composed of thermoelectric couples (N and P-type doping semiconductor legs) that are connected electrically in series, in parallel thermally and, fixed by soldering, sandwiched between two ceramic plates. The latter form the hot and cold thermoelectric cooler (TEC) sides.

A TE module consists of the following two components:
Regular matrix of TE pellets (elements). Requirements for the thermoelectric pellet materials are: 1) Heavy elements due to their high mobility and low thermal conductivity, 2) Narrow band-gap semiconductors due to ambient temperature operations, 3) Large unit cells with a complex structure, 4) highly anistropic and/or highly symmetric units, and 5) complex compositions.
Metals with their low electrical resistance would provide somewhat effectively until the high thermal conductivity is considered and how quick excessive thermal increase will destroy the TEC unit subsequent to destroying the ZT.
   Thermoelectric semiconductor materials include the following: Lead Telluride (PbTe), Silicon Germanium (SiGe), bismuth Antimony (Bi—Sb) alloys and the one chosen and selected for one embodiment is Bismuth Telluride (Bi2Te3). Bismuth Telluride has two distinct characteristics which qualify it as the first choice in a pellet material. First, due to its crystal structure, Bismuth telluride is highly anistropic. It has an electrical resistance approximately 4 times greater parallel to the axis of crystal growth that perpendicular to it. Conversely, thermal conductivity is approximately double parallel to the crystal-growth axis than the perpendicular direction. Therefore, the anistropic behavior of resistance is greater than that of thermal conductivity, and the highest figure of merit occurs in the parallel orientation utilizing this material, the thermoelectric elements must be incorporated into a TEC module sin a manner that the crystal growth axis is parallel to the length of each pellet element (perpendicular to the ceramic plates), so that this anistropic attribute is exploited for optimum cooling. Additionally, Bismuth Telluride crystals are made up of hexagonal layers of similar atoms.
   Testing has validated that the utilization of a small module with a large pellet footprint performs better than typically commercially manufactured systems. Thermoelectric cooler capacity is dependent upon the number of pellets and their geometry. Low weight pellets and/or larger pellets cross-sections provide increased cooling capacity value for the TEC. Additionally, they increase the operating output and total power consumption. Smaller pellet cross-section and tall pellets increase maximum temperature differences and reduce the TEC power consumption, with a slight reduction in cooling capacity.
Ceramic plates, which produce cold and warm (and intermediate for multi-stage coolers) ceramic layers of a module. The plates provide mechanical integrity of a TE module. They must satisfy strict requirements of electrical insulation from an object to be cooled and the heat sink. The plates must have good thermal conductance to provide heat transfer with minimal resistance. The aluminum oxide (Al₂O₃) ceramics is used most widely due to the optimal cost/performance ratio and developed processing technique. Other ceramics types, such as aluminum nitride (AlN) and beryllium oxide (BeO), are also used. They have much better thermal conductance—five to seven times more than Al₂O₃—but both are more expensive. Additionally, beryllium oxide (BeO) technology is poisonous, precluding its use in this technological application. Both the aluminum nitride (AlN) and the aluminum oxide (Al₂O₃) ceramics are utilized each in different embodiments.

A single-stage module consists of one matrix of pellets and a pair of cold and warm sides, as depicted in FIG. 7.

Thermoelectric cooling units are considered, construction based, as very reliable, a critical requirement for the EOD unitized bomb disposal suit. The temperature gradient from the operating ambient temperature range can be extended by the choice of suitable thermoelectric cooling modules.

The typical Mean Time between Failure (MTBF) for thermoelectric modules of Kryotherm is approximately 100,000 to 200,000 hours at ambient temperature, and a maximum of 250,000 to 350,000 hours at ambient temperature with a steady state of constant power, heat loading, temperature, physical stresses and mounting applications, etc. However applications involving thermal cycling have demonstrated significantly worse MTBF's, especially when the TE coolers are cycled up to a high temperature. With thermal cycling, a more appropriate measure of reliability is not in time but rather in the number of cycles. Conversely, the life cycle of the utilized fans in current forced ambient air fan systems is much shorter. Through testing it was determined that to minimize the impact of thermal cycling, minimizing the temperature range of the cycle and minimizing the number of thermal cycles aided in reducing the thermal cycling impact. The smaller the module size the more reliable it is inclined to be, and the larger the pellet footprint, the more reliable it is inclined to be.

In the thermoelectric system, the cooling capacity is dependent upon the current provided. These smaller unit modules are typically built for use with a constant dc voltage of 12 volts. It has been found that reducing the maximum ripple of 5% is optimal for the maximum cooling operation. The TEC will be mounted into the bifurcated venturi air circulation delivery system, and will provide for the drainage and dissipation of the condensation created by the TEC.

A controller is used to maintain the current load. Temperature control methods have an impact on thermoelectric module reliability. The standard ON/OFF type of controller creates thermal cycling that can destroy the integrity of the TEC. As the TEC assembly is thermally cycled, not only does the module itself undergo fatigue stress, the bond line between the module and the heat sink is stressed. Different materials expand and contract at different rates. Therefore, an improvement on typical ON/OFF controlled TEC devices currently utilized have lower life spans in the attempt to gain as much heat transfer as possible, which creates thermal cycling from increased temperature loading fluctuations. To minimize the impact of thermal cycling, minimizing the temperature range of the cycle and the number of full thermal cycles is a necessary prerequisite. In one embodiment a Linear or pulse-width-modulated (frequency of at least 300 Hz) control has been determined to reduce the detrimental effects of temperature cycling by effective rapid switching at this frequency, as compared to the industry standard slower rate ON/OFF control for increased reliability. This TEC controller can utilize variable frequency ranges from approximately 300 Hz to 3,000 Hz, and utilizes a set of smaller modules with larger pellet footprints.

Utilizing pulse-width-modulated power to operate the TE device utilizes a rapidly switched “ON” and “OFF” at a constant frequency. This creates a square wave “pulse” of power with a constant time period, instead on a typical rounded sine wave with transitioned increasing and decreasing voltages. The “ON” time, or pulse width, can be varied to create an average output voltage (V average) that is required by the TE device to maintain the set temperature. FIG. 8 illustrates how pulse-width modulation functions.

The “ON” and “OFF” pulses occur so rapidly that the module does not have enough time to change temperature in response to each electrical pulse. Instead, the module assumes a temperature difference relative to Vaverage. When the controller is properly tuned thermal cycling is eliminated. Therefore, these controllers preclude degrading the reliability of a module from thermal cycling in the same way that a thermostatic or slow “ON-OFF” controller would.

All controllers require some minimum voltage to operate the on-board microprocessor. The minimum voltage can be anywhere from 9 VDC up to 50 VDC, depending on the controller. In one embodiment a 9 VDC controller is utilized to reduce the maximum drain on battery life. In another embodiment a 12VDC controller is utilized as it has an increase ability to stabilize the pulse width in a shorter and more efficient manner. If the thermoelectric load can also be driven with this input voltage then only one power supply is needed for the application. All of TEC standard thermoelectric cooling assemblies are designed so that the assembly and a controller can operate from one power supply.

When operating from one power supply the input voltage to the temperature controller will define the output voltage during the “ON” portion of the waveform, and Vaverage will range anywhere from 0 V to V+ depending on the ratio of “ON” time to “OFF” time. In the waveforms shown in FIG. 8, the V+ is equal to the input voltage from the power supply, and during the “ON” cycle of the waveform V+ will be applied across the thermoelectric load. Therefore, when utilizing a single power supply, an input voltage that is no greater than the Vmax of the cooling assembly or thermoelectric module(s) is of critical importance. Additionally, the maximum operating voltage (the controller's input voltage) should be no more than 75% of module's Vmax.

However, when wiring multiple modules in series or in a series-parallel combination, Vmax of the module system will be the Vmax of each module multiplied by the number of modules in series. In this case, the input voltage is generally no more than 75% of the module system.

When operating a thermoelectric module at a voltage that is less than what is required to operate the controller's microprocessor, which is not only possible but in one embodiment provided power consumption confidence, a temperature controller that allows the microprocessor and thermoelectric load to be powered by two independent power supplies, is power safety redundancy. In this configuration the microprocessor can be powered by a small, higher voltage supply and the thermoelectric load can be powered with a supply that, in theory, is as low as 0 V. Referring again to the waveforms in FIG. 8 this allows the user to select a V+ that is suitable for a low-voltage thermoelectric load while still providing the microprocessor enough voltage to operate.

Another improvement of the TEC in one embodiment is nickel plating the copper conductors that connect the pellets together. The copper metal has a tendency to diffuse into the thermoelectric material, which in turn degrades the thermal performance. Plating the copper with nickel aids as a diffusion reducing barrier, increasing the life span of the TEC by reducing the rate of time that the cooper diffuses into the thermoelectric pellet material. The higher the operating temperature of the TEC the quicker the copper diffusion rate will be.

Additionally, typical modules with nominal high operating temperatures in the range of 176° F./80° C., ±10° F./−12.2° C. effect solder constituent materials. Eutectic alloys for soldering, composed of tin (Sn), lead (Pb), silver (Ag), gold (Au), and specifically Sn63Pb37 (a high purity alloy that is composed of 63% tin and 37% lead alloy formula designed specifically for electronics), which will migrate along the cleavage planes of the thermoelectric material due to a minor type of eutectic reaction. This eutectic process is an invariant reaction, because it is in thermal equilibrium; another way to define this is the Gibbs free energy equals zero. Tangibly, this means the liquid and two solid solutions all coexist at the same time and are in chemical equilibrium. There is also a thermal arrest for the duration of the phase change during which the temperature of the system does not change. When a non-eutectic alloy solidifies, its components solidify at different temperatures, exhibiting a plastic melting range. Conversely, when a well-mixed, eutectic alloy melts, it does so at a single, sharp temperature, resulting in the transition phase.

The resulting solid macrostructure from a eutectic reaction depends on a few factors. The most important factor is how the two solid solutions nucleate and grow. The most common structure is a lamellar structure (characterized by a composition of fine, alternating layers of different materials in the form of lamellae), but other possible structures include rod like (characterized by a smooth round elongated shape rather than a jagged elongated shape), globular (characterized by a small spherical mass), and acicular (characterized by needle-shaped crystallites or grains when viewed in two dimensions. The grains, are actually three-dimensional in shape, have a thin lenticular shape. This microstructure is advantageous over other microstructures because of its chaotic ordering, which increases toughness). This increases the likelihood of a weakened solder joint with a physical expansion of the TEC pellet material. Another set of reasons for utilizing smaller modules coupled as compared to a single larger module.

The air-recirculation DCJ, ThinSink™ forced convection, or other forced air circulation embodiment units are coupled to the TE and the slowly chilled air is circulated throughout the over-suit and into the helmet with a slight overpressure. This overpressure forces chilled air to circulate through the helmet and outward down towards the neck. Within the over-suit the positive overpressure forces air to circulate through the arms and legs out through the cuffed ends. A proportional amount of chilled air is also re-circulated back through the chiller to further be reduced in temperature, and again recirculated through the entire suit assembly. The DCJ units are designed to provide a nominal throughput circulatory flow of approximately 2 cubic feet per minute through the helmet and 8 cubic feet per minute through the suit.

Current suits do not circulate air through the suit, only through the helmet and typically at a nominal flow rate of only 2 to 3 liters per minute. The human body during breathing inhales more air than that. Additionally, the current suits employ one or more fans that blow air into the helmet from the outside. In an arid area that is over 43.3° C./110° F., the fans do not provide much cooling even to the head. The human body is exceptionally self-regulating and sweat is produced to keep the core temperature down. During vigorous activities, the human body produces heat and a certain amount of water vapor. If the heat emission is no longer sufficient to keep the core temperature of the body at about 37° C./98.6° F., the body will produce liquid sweat. The optimum form of sweat utilization for the body is the evaporation of moisture directly from the skin to be released as water vapor. This is true as most of the heat energy needed to evaporate the moisture is extracted from the body causing body temperature to drop. Only via the evaporation of liquids can the body efficiently cool itself at high physical loads.

Since little to no air is circulated between the current EOD suits and the skin, that semi-closed area rapidly heats up as cellular metabolism releases heat from the body.

The only option offered currently is a chilled water pumping circulation system, which circulates chilled water through tubing as the tubing runs through an ice pack. The negative issues with this type of system are:
The two to three liter bottler of water strapped to the leg, and the associated weight, along with an additional object strapped to the outside of the body that could get snagged on something;
The limited time until the ice melts, typically within ten minutes;
The extra weight of the inner cooling suit with all of the added hosing and material which is added weight, and which will retain more heat once the ice system has melted, and the extra space it takes inside the suit further reducing the already limited movement restricting space inside the suit.

Normally the body dissipates heat by three mechanisms:
1. Conduction
2. Convection
3. Evaporation

Conduction moves heat energy away from the body to the molecules of cooler objects in contact with the skin.

With convection, heat is conducted to cooler surrounding air molecules in contact with the body and as the air becomes heated, it moves away from the body and is replaced by cooler air creating a current of circulating air.

To allow evaporation cooling to work, as the body temperature rises above normal, sweat glands are stimulated to release sweat onto the skins surface and the fluid evaporates carrying the heat with it thus cooling the skin. One consideration concerning evaporation is the humidity of the surrounding air. As humidity, the moisture saturation of air, increases, evaporation will decrease; thus in a semi-closed insulated environment as the space between the body and the EOD suit, where humidity generally increases quickly, there will be little to no evaporation.

To assist with the conduction, convection and evaporative process required to cool the EOD technician within the EOD suit, the additional use of an interface ribbed shirt undergarment and/or leggings as utilized as an essential part of the total ensemble for wearing the EOD unitized bomb disposal suit. This interface is the common boundary or interconnection between the personal protective equipment, and the EOD technicians wearing it. The interface is in itself a type of safety garment designed to preclude overheating, heat prostration/exhaustion, dehydration, hypothermia, abrasion and blistering, and possible death. Of these the risk to personal safety is affected the greatest by overheating, a condition characterized by faintness, dizziness, abdominal cramping, rapid pulse, nausea, profuse sweating, cool skin, weakness, and collapse, caused by prolonged exposure to heat accompanied by loss of adequate fluid and salt from the body.

The interface ribbed shirt undergarment and/or leggings are manufactured of a Dacron® polyester fiber material, using a fabric structure having improved elasticity, compression, breathability and thermoregulation characteristics. These appropriately designed ribbed undergarments enhance the removal of perspiration from the skin, regulate body temperature, provide pressure relief, and protect the skin from abrasion. The ribbed shirt undergarment and/or leggings are designed to wick moisture away from the body through capillary flow into the cording material which provides for a stand-off spacing relief for air circulation between the body and the components of the unitized EOD bomb disposal suit. The distance between the cording provides vertical air circulation channels that aid in the convection and evaporation of the sweat produced by the body. The Dacron® polyester material is designed with greater amounts of surface area to mass allowing for greater amounts of conduction and convection due to the mesh design in addition to the fiber design of the polyester material.

Friction is a non-normal force and is dependent on the surface characteristics of the textile material and body skin in contact. Frictional force acts parallel to the two contacting surfaces and resists sliding motion resulting in abrasion and blistering. Pressure is a factor that enables the friction/shear to reach traumatic levels to the surface of the skin, especially if it is wet. To differentiate shear and friction, shear occurs within an object, such as between layers of skin. Shear, like friction, is a parallel force, of two equal and opposite forces that act to displace one part of an object with respect to an adjacent part. The interface ribbed shirt undergarment and/or leggings reduce frictional force over the very thin protective underwear garment from the unitized EOD suit components to the body by pushing away from direct contact with the thin textile lying directly against the skin. The cording precludes friction across the entire torso by only having the pressure applied to the soft, compressible, all cotton ribbed cording points.

Additionally, utilizing specifically designed textile fabrics with low frictional coefficient's, as the polyester textile is, does reduce shear between the body and contacting interface, thus decreasing the likelihood of abrasion of the skin, leading to blistering.

Another technology that will be integrated into the re-circulation process of the chilled positive pressure air is a method to reduce moisture through a desiccant absorbent built into the suit manifold and helmet. This will further aid in reducing the fogging affect of the helmet face shield, as the EOD operator exhales, and reacts with the re-circulating air to pull moisture into the absorbant that can be removed and replaced with each operation.

This will be coupled with a High-Efficiency Particulate Air “HEPA” filter designed to remove at least 99.97% of airborne particles 0.3 micrometers (μm) in diameter from being drawn in and circulated within the helmet and suit. HEPA filters are composed of a mat of randomly arranged fibers. This type of filter couples minimal resistance to airflow, and pressure drop. The fibers are typically composed of fiberglass and possess diameters between 0.5 and 2.0 micrometers. Key factors affecting function are the fiber diameter, filter thickness, and face velocity. The air space between HEPA filter fibers is much greater than 0.3 μm. The common assumption that a HEPA filter acts like a sieve where particles smaller than the largest opening can pass through is incorrect. Unlike membrane filters at this pore size, where particles as wide as the largest opening or distance between fibers cannot pass in between them at all, HEPA filters are designed to target much smaller pollutants and particles. These particles are trapped (they stick to a fiber) through a combination of the following three mechanisms:

1. Interception, where particles following a line of flow in the air stream come within one radius of a fiber and adhere to it.

2. Impaction, where larger particles are unable to avoid fibers by following the curving contours of the air stream and are forced to embed in one of them directly; this effect increases with diminishing fiber separation and higher air flow velocity.

3. Diffusion, an enhancing mechanism that is a result of the collision with gas molecules by the smallest particles, especially those below 0.1 μm in diameter, which are thereby impeded and delayed in their path through the filter; this increases the probability that a particle will be stopped by either of the two mechanisms above; and it becomes the dominant factor at lower air flow velocities.

Diffusion predominates below the 0.1 μm diameter particle size. Impaction and interception predominate above 0.4 μm. In between, near the Most Penetrating Particle Size (MPPS) 0.3 μm, both diffusion and interception are comparatively inefficient. Because this is the weakest point in the filter's performance, the HEPA specifications use the retention of these particles to classify the filter.

Lastly, it is important to note that HEPA filters are designed to arrest very fine particles effectively, but they do not filter out gasses and odor molecules. Circumstances requiring filtration of volatile organic compounds, chemical vapors, require the use of an optional activated carbon (charcoal) pre or post filter in addition to a HEPA filter.

The over-suit is designed for quick donning and quick release doffing. The oversuit exterior is constructed of water repell and flame retardent treated 1000 denier Cordura®. With an internal rip-stop Nomex® internal lining. It is designed as a single unit without the typical heavy thick and bulky, movement restricting multiple component trousers, suspenders, top and groin/crotch diaper.

All of the ballistic and/or fragmentation resistant panels are removable for care and cleaning of the vest and over-suit outer carrier textiles.

All of the removable ballistic and/or fragmentation resistant panels are designed to preclude seams or gaps in coverage with substantial overlaps and high tenacity grip double overlocking Velcro® closures.

The armpit and crotch areas have a reinforced “diamond shaped gusset” that allows for a greater free range of motion, without the over-suit constricting and binding around the arms and legs resisting range of motion. The elbow and knee regions will have pleated regions of extra material that will allow for additional free range of motion without pulling up on the wrist or ankle oversuit coverage.

The elbow and knee areas have “non-slip, non-skid” elastomeric and EPDM rubber pads to preclude tearing the over-suit textile, reducing the possibility of slippage/skidding when going to a knee or knees and/or elbows stabilizing the stance and position of the EOD technician.

Additionally, a light weight resiliently compressible energy absorbing material is built into the elbow, knee, and upper through lower lumbar vertebrae spine regions, as in the helmet mentioned on page 15 to protect against tertiary injuries from an explosive detonation.

The power supply will be produced through a “power pack” quick re-change plug-in design system, allowing for a rapid changing of a batter pack when or if necessary. The battery will of a polymer design as compared to the lithium ion or other standard rigid cell batteries, with an 8× to 10× increase in charge capability, with increased cycling capabilities without having contact or cathode breakdown due to the unique silicon design.

Augmentation power in one embodiment would be through the use of a flexible extremely thin solar panel attached to the back of the oversuit. In another embodiment the utilization of TE generator harnessing the diffused waste heat from the TEC to generate power to replace used stored energy or the augment as an additional power subsystem.

The current suit designs are not designed to handle the larger more commonly faced IED threats being utilized today. The current .22 caliber, 17 grain fragment simulating projectile (FSP) even at the highest velocity of 775 m/s-2,542 feet per second is only close to what IEDs designed from artillery munitions discharge during detonation, but at a distance of slightly over 17 meters/55.77 feet, and are more common to “pipe bomb” threats. The 7.62 mm/.30 caliber 44 grain FSP is closer to the smallest sized fragmentation that such artillery rounds are designed to produce.

However, the greater percentage of fragmentation and shrapnel threats are from 12.7 mm/.50 caliber to 20 mm in size. The US Army Research Center undertook an analysis of the small arms and fragment threats in Iraq and Afghanistan that should be utilized in the design and development of armor. They concluded that the most dangerous current threat is that posed by fragments generated from IEDs, come in a multitude of configurations and explosive loads. However, the main fragment threat is from command detonated artillery projectiles that generate large numbers of fragments and blast close to light armored vehicles on roads in Iraq and Afghanistan.

A typical device would be a 152-mm or 155-mm artillery projectile with a TNT or C4 charge and detonator, direct wire linked or command detonated by radio. The employment generally involves concealing the projectile along the road with the projectile parallel to the road, buried in the ground or in a pile of stones, mounted on a structure or against a curb. These uses have significantly changed the fragmentation patterns generated from air-bursts.

The use of fragment simulating projectiles (FSP) has become the norm in developing armors that protect against fragments. The family of FSP's is described in MIL-P-46593A. These mild and hardened steel, chisel-nosed, right circular cylinders are designed in various caliber sizes and masses. F or light armor applications, the primary FSP's are the 0.30-cal 44-grain, the 0.50-cal 207-grain and the 20 mm 830-grain projectiles. See FIG. 8.

The most widely used ballistic fragment data sets were those for the Soviet 152-mm OF540 artillery projectile with a TNT fill and the U.S. 155-mm M107 projectile with a Comp-B fill.

Variations of these projectiles are readily available in Iraq as the projectiles were fired in both towed and self-propelled artillery in the former Iraqi Army, and were left behind by the Soviets during their pullout from Afghanistan by the thousands.

The OF540 projectile contains 5.9-kg/13.0-lb of TNT in a standard Soviet design that is similar in fragmentation characteristics to other Soviet and Western artillery projectiles such as the Soviet 122-mm OF462 (TNT); the U.S. 155-mm M107 projectile contains 6.98 kg/15.4-lb of Composition B explosive.

The fragmentation characteristics of these three projectiles are illustrated in FIG. 9; the vertical axis represents the percentile fragment and shows the similar fragmentation sizes for these projectiles. For example, the 830-grain FSP represents the 94th percentile fragment when the 152 mm OF540 projectile is detonated, i.e., 94% of the fragments would have a mass equal or less than the 20-mm FSP.

The fragment sizes when combined with the impact velocity can provide a qualitative analysis of the protection for an armor system. Fragmentation characteristics as defined in FIG. 10 are for ammunition with a cylindrical casing and are calculated using the methods described in US Army Technical Manual 5-1300 (TM 5-1300), Section 2-17.2.

The velocity characteristics of the fragments are dependent on the explosive type and explosive weight. In normal applications, when fired from an artillery tube, the fragment velocity has both a terminal velocity and burst velocity. However, the terminal velocity of an artillery projectile when used as an IED is zero and the burst velocity of explosive in the projectile represents the highest fragment velocity. The U.S. M107 with a higher brisant Comp-B explosive filler is a significantly greater threat than the Soviet OF-540.

While the fragment sizes are similar for the two projectiles OF540 and M107, the burst displacement velocity of the fragments from the detonation of the explosive, is significantly higher for the M107 as compared to the OF540. The OF540 is at (1,067 m/s) 3,500 fps and (1,519 m/s) 4,983 fps for the M107. The horizontal axis of FIG. 6 shows the drop off in fragment velocity from drag as the target is moved away the detonation point.

The accepted distance for IED encounters in Iraq is 4 meters/13.1′ that represents the average distance from the edge of the road to vehicles moving on multi-lane roads. The percentile fragments are also shown in FIGS. 9 and M107 has a slightly larger percentage of fragments for the three FSP's. DoD 6055.9-STD defines a hazardous fragment as one having an impact energy of 58 ft-lbs or greater. Additionally, this standard provides a default separation distance for protection of: 2500 feet for fragmenting explosive materials with a diameter less than 5 inches; and 4000 feet for bombs and projectiles with a diameter of 5 inches or greater.

FIG. 10 is a graph illustrating burst distance and velocity as a function of range for the 152 mm OF540 and the 155 mm M107 Artillery Projectiles when used as an IED.

The ceramic composite torso vest has been tested to each of the Soviet OF540 and the U.S. M107 artillery threats detonated at 3.93 meters/12.9′, with complete defeat of the fragmentation threats at burst. This is the first time an EOD suit has been capable of defeating such a large threat.

The Torso Vest Component in Addendum a was Tested to and Defeated the Soviet OF540 Artillery Threat.

The fragmentation testing was completed with the SOV2000 level 3 rifle threat defeating flexible body armor targets. The test was to determine the extent of fragmentation resistance offered against a typical roadside detonation of the Soviet 152 mm OF540 artillery projectile. The standoff distance was 3.93 meters/12.9′ from the artillery projectile, and was set up to be centered in the focused dispersion pattern center to assure the greatest amount of impacts from the 44, 207, and 830 grain fragmentation simulating projectiles. This also allowed for a much more accurate replication of a close proximity roadside detonation with as close to the 3,500 feet per second burst displacement velocities as practical.

The 12.9′/3.93 meter standoff distance had the following fragment simulating projectiles impacting the SOV2000 level 3 rifle flexible defeating diagnostic targets at recorded speeds of:
20 mm, 830 grain at 1,044 meters per second/3,425 feet per second.
12.7 mm, 207 grain at 1,025 meters per second/3,362.82 feet per second.
7.62 mm, 44 grain at 994 meters per second/3,261.11 feet per second

The associated fragmentation categories will be defined initially by dimension and categorized as: zero to 7.62 mm, greater than 7.62 mm up to 12.7 mm, greater than 12.7 mm up to 20 mm, and greater than 20 mm. The recovered mass of the fragments does not include all of the impacted fragments. During the forensic examination, it was found that a substantial amount of the zero to 7.62 mm impact locations did not have fragments located within the strike areas. The fragmentation projectiles left impact marks on the textile covering, but did not have enough momentum mass and energy to substantially damage the ceramics enough to lodge them into the interior of the textile backing, and were subsequently rebounded backwards out of the target. This was evident upon the extremely small amounts of ceramic damage and the lack of impacts into the textile backing material directly behind the ceramic discs.

The fragment dimensions listed on each diagnostic array chart are based upon the size or circumference of the impact holes in the strike face of the armor. A fragment mass could be shaped like a “long-rod penetrator” with a very small impacting surface area with a substantial elongated driving mass behind it. These tend to be over several inches long such as the recovered 4.25″/107.95 mm long by .945″/24 mm diameter fragment #24 of the diagnostic target array #2 with a ending retrieved mass of 1,250 grains. Another similar fragment, is the recovered fragment #23 of the diagnostic target array #6 which was actually split into 3 fragment elements, two of the retained pieces with a nominal mass of 349.3 grains. The larger piece measured in a straight line across the crescent arc was 3.75″/95.25 mm by approximately .827″/21 mm in diameter.

The following defeated FSP fragmentation data for the Soviet OF540 is defined the chart below based upon fragmentation size category, number of fragments per such category and the mass weight variables in grains, and the recovered remnant mass lying at the bottom of the SOV2000 armor target, that did not penetrate, impacted and fell to the bottom of the target. The overpressure was not recorded.

The focused dispersion pattern as tested only accounts for approximately ⅙^{th} of the fragment dispersement from the entire projectile. However, it does guarantee an increased concentration of fragmentation within a focused impact area at the stand-off distance from the epicenter of the projectile to the face of the target.

Soviet OF540 Artillery Projectile Fragmentation Test

| | | Fragment | Fragment | Recovered |
|---|---|---|---|---|
| | Fragment | Weight | Weight | Remnant |
| Catagory | Quantity | Low-high | Averaged | Mass |
| 0-7.62 mm | 92 | 71.8-572.5 | 87.74 | 196.2 |
| 7.62 mm-12.7 mm | 48 | 52.8-184.1 | 133.47 | grains |
| 12.7 mm-20 mm | 23 | 25.7-888.8 | 198.73 | |
| [symbol] 20 mm | 38 | 106.6-1.250 | 541.78 | |

The Torso Vest Component in Addendum B was Tested to and Defeated the U.S. M107 Artillery Threat.

The fragmentation testing was completed with the SOV3000 level 4 rifle threat defeating flexible body armor targets. The test was to determine the extent of fragmentation resistance offered against a typical roadside detonation of the U.S. 155 mm M107 artillery projectile. The standoff distance was 13.12°/4.0 meters from the artillery projectile, and was set up to be centered in the focused dispersion pattern center to assure the greatest amount of impacts from the 44, 207, and 830 grain fragmentation simulating projectiles. This also allowed for a much more accurate replication of a close proximity roadside detonation with as close to the 4,893 feet per second burst displacement velocities as practical.

The overpressure measurements at 6.56′/2 meters was 219 PSI, and the overpressure measurements at 13.12′/4 meters was 46 PSI. The overpressure shock wave arrived at the armor panel target in 5.447 milliseconds.

The 13.12′/4.00 meter standoff distance had the following fragment simulating projectiles impacting the SOV3000 level 4 rifle flexible defeating diagnostic targets at recorded speeds of:
20 mm, 830 grain at 1,123.19 meters per second/3,885 feet per second.
12.7 mm, 207 grain at 1,039.06 meters per second/3,609 feet per second.
7.62 mm, 44 grain at 936.65 meters per second/3,473 feet per second

The fragment dimensions listed on each diagnostic array chart are based upon the size or circumference of the impact holes in the strike face of the armor.

The following defeated FSP fragmentation data for the U.S. M107 is defined the chart below based upon fragmentation size category, number of fragments per such category and the mass weight variables in grains, and the recovered remnant mass lying at the bottom of the SOV3000 armor target, that did not penetrate, impacted and fell to the bottom of the target.

US M107 Artillery Projectile Fragmentation Test

| | | Fragment | Fragment | Recovered |
|---|---|---|---|---|
| | Fragment | Weight | Weight | Remnant |
| Catagory | Quantity | Low-high | Averaged | Mass |
| 0-7.62 mm | 155 | 12.6-102.33 | 76.76 | 704.56 |
| 7.62 mm-12.7 mm | 60 | 166.78-301.17 | 203.98 | grains |
| 12.7 mm-20 mm | 56 | 207.28-901.12 | 369.46 | |
| [symbol] 20 mm | 2 | 421.32-975.88 | 698.60 | |

The focused dispersion pattern as tested only accounts for approximately ⅙th of the fragment dispersement from the entire projectile. However, it does guarantee an increased concentration of fragmentation within a focused impact area at the stand-off distance from the epicenter of the projectile to the face of the target.

The higher brisance creates a greater concentration in the 98% designed range as compared to the OF540 and the lower detonation speed of the TNT, which results in a greater variant of projectile size and mass.

The Over-Vest Component in Addendum C was Tested to and Defeated the Following In-House Low Level Fragmentation Simulating Projectiles.

The over-vest component was initially tested for low level fragmentation into two configurations of the constituent composite materials. These are the all ballistic/fragmentation resistant textile component such as those described in U.S. Pat. No. 6,705,197, which is incorporated by reference, and the ballistic/fragmentation resistant textile component with the X-2+™ technology used as the strike face component. The velocities are based on V₅₀ testing. Higher level low eight fragmentation testing is currently being conducted to increase the all textile and X-2+ technology performance capabilities with optimized weight design.

All Textile Component

Right Circular Cylinder fragment simulating projectiles (RCC)

2 grain RCC—2,774 fps.

4 grain RCC—2,461 fps.

16 grain RCC—2,061 fps.

64 grain RCC—1,736 fps.

Fragment Simulating Projectiles (FSP)

.22 caliber 17 grain FSP—1,937 fps.

.30 caliber 44 grain FSP—1,659 fps.

X-2+™ Strike Face Component

Fragment Simulating Projectiles (FSP)

.30 caliber 44 grain FSP—2,624 fps.

.50 caliber 207 grain FSP—1,561 fps.

FIG. 19-FIG. 28 illustrate each of the various aspects of the protective garment described herein. Representatively, FIGS. 19, 20 and 21 show a front, back and side view, respectively, of one embodiment of a protective garment. From these views, it can be seen that the protective garment includes an outer garment which forms both a jacket and pant portion of the protective suit. The jacket and pant portion are sewn together such that they form one unitary suite. FIG. 22 illustrates a magnified view of a reinforced arm region of the protective garment of FIG. 19. From this view, it can be seen that the underarm region of the outer garment includes a diamond shape gusset which provides reinforcement and extra material to prevent pulling of the suit arms above the wrists and prevents the pulling of the suit bottom upwards thereby exposing the ankles when the user lifts the arm as shown.

FIGS. 23-24 illustrate a front and side view, respectively, of an inner vest of the protective garment of FIG. 19. As previously discussed, the inner vest may be formed of reinforced ceramic discs or plates that cover the entire torso, front, sides and back, to provide added protection. In addition, from this view, it can be seen that the jacket portion of the outer garment includes an opening along the front. The user can use this opening to put the pants portion on, followed by the jacket portion. Once in place, the suit can be closed by securing the jacket opening to the opposing jacket sides as well as the adjustable waistband of the pants portion. In some embodiments, Velcro strips are sewn along the jacket and pants as shown to allow for closure of the suit.

FIG. 25 illustrates a magnified view of a reinforced groin region of the protective garment of FIG. 19. The illustrated gusset in the groin region helps to prevent the pants from pulling up and exposing the ankles when the wearer bends at this region, such as to squat, and when raising the legs in a forward, rearward or lateral high position, such as climbing or straddling objects, voids, etc.

FIG. 26 illustrates a front view of a leg region of the protective garment of FIG. 19. From this view, it can be seen that the leg regions of the pants may include an opening to facilitate positioning of the pant legs over the legs and/or a boot. An attachment mechanism such as a Velcro may be used to open and close the leg opening. From this view, it can also be seen that the pant portion includes an extended adjustable flap which covers the user's ankle inside and outside and the top portion of the foot.

FIG. 27 illustrates a front view of a reinforced knee region of the protective garment of FIG. 19. The reinforced knee region includes extra material as can be seen, so that when the wearer kneels, the pants do not pull up over the ankles

FIG. 28 illustrates a front view of a reinforced elbow region of the protective garment of FIG. 19. Similar to the knee region, the elbow region includes extra material so that when the user bends the elbow, the sleeve does not pull up over the wrists. In addition, the knee and elbow regions may include a non-slip and/or rubber external reinforcement material as previously discussed.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

### ADDENDUM A

Rifle defeating capabilities with multiple repeat hit capabilities of 2″ separations between shots.

| Dragon Skin ® Ball & mild steel core | Velocity |
|---|---|
| 7.92 × 57 mm (8 mm Mauser)197 gr. FMJ LB | 2415 ft/sec + 100 |
| 7.70 × 56 mm (.303 British) 174 gr steel case mild | 2470 ft/sec + 100 |
| steel core | |
| 7.62 × 66 mm (.300 Winchester Mag) 150 gr, FMJ | 3190 ft/sec + 50 |
| 7.62 × 63 mm (30-06)180 gr. SP | 2540 ft/sec + 100 |
| 7.62 × 54 mm (Russian) 147 gr. FMJ | 2623 ft/sec + 100 |
| 7.62 × 54 mm (Russian)180 gr. FMJ | 2630 ft/sec + 100 |
| 7.62 × 51 mm (.308) 148 gr, FMJ | 2900 ft/sec + 100 |
| 7.62 × 39 mm (AK-47)150 gr. FMJ | 2400 ft/sec + 100 |
| 5.45 × 39 mm (AK-74)150 gr. FMJ | 3000 ft/sec + 100 |
| 5.56 × 45 mm (.223) 55 gr FMC, M-193 | 3000 ft/sec + 100 |
| 7.62 × 39 mm (AK-47) 122 gr. Steel case, mild core | 2300 ft/sec + 100 |
| (PS) | |
| 5.56 × 45 mm (.223) 62 gr. M855 (SS109 Green Tip) | 3200 ft/sec + 100 |

This system will also defeat the threats in addendum C.

### ADDENDUM B

Rifle defeating capabilities with multiple repeat hit capabilities of 2″ separations between shots.

| Dragon Skin ® Armor Piercing & Incendiary | Velocity |
|---|---|
| 7.62 × 63 mm 166 gr AP M2 | 2880 ft/sec + 100 |
| 7.92 × 57 mm 156 gr mild steel core (LPS) | 2750 ft/sec + 100 |
| 7.62 × 54 R mm 155 gr steel case API B32 | 2850 ft/sec + 100 |
| 7.62 × 54 R mm 184 gr steel case AP B30 | 2850 ft/sec + 100 |
| 7.62 × 54 R mm 153 gr steel case API Type 53 | 2675 ft/sec + 100 |
| 7.62 × 54 R mm 148 gr steel case, hardened steel core | 2800 ft/sec + 100 |
| Type 53 | |
| 7.62 × 54 R mm 147 gr steel case, mild steel core | 2723 ft/sec + 100 |
| (LPS) | |
| 7.62 × 51 mm 151 gr M61 AP | 2800 ft/sec + 100 |
| 7.62 × 39 mm 120 gr API BZ | 2600 ft/sec + 100 |
| 7.62 × 39 mm 118 gr API Type 56 | 2600 ft/sec + 100 |
| 7.62 × 39 mm 122 gr steel case, mild steel core (PS) | 2500 ft/sec + 100 |
| 5.56 × 45 mm 62 gr M855 (SS109 Green Tip) | 3500 ft/sec + 100 |
| 5.45 × 39 mm 53 gr 7N6 | 2920 ft/sec + 100 |
| 5.45 × 39 mm 57 gr 7N10 | 3051 ft/sec + 100 |

This system will also defeat the threats in addendum A and C.

### ADDENDUM C

Armor piercing pistol defeating capabilities with multiple repeat hit capabilities of 1″ separations between shots.

| Survivor Series ™ Extreme with X2+ ™ Technology | Velocity |
|---|---|
| 7.62 × 25 mm 86 gr steel case, lead core | 1400 ft/sec + 50 |
| 9 mm 107 gr KTW Teflon coated brass | 1250 ft/sec + 50 |
| 7.62 × 25 mm 85 gr steel core | 1450 ft/sec + 50 |
| 9 mm 100 gr CZ steel case, steel core | 1250 ft/sec + 30 |
| .357 Magnum 107 gr, KTW Teflon coated brass | 1400 ft/sec + 50 |
| 7.62 × 25 mm 85 gr solid steel | 1450 ft/sec + 50 |
| 12 Gauge 1 oz Slug, 3″ Chamber - 20″ Barrel | 1450 ft/sec + 50 |
| 5.7 × 28 mm 31 gr, SS190 - 4.8″ Barrel | 2050 ft/sec |
| 5.7 × 28 mm 27 gr, SS192 - 4.8″ Barrel | 2132 ft/sec |

What is claimed is:

1. A protective suit for protecting personnel from explosive blast detonation and ballistic threats, the protective suit comprising:
a rifle defeating flexible ballistic and fragmentation resistant inner body armor vest with coverage designed to wrap completely around a torso and abdomen of a body;
an outer garment coupled to the inner body armor vest, the outer garment being one unitary garment dimensioned to cover the body from the base of the foot up to the head and outward to the wrists;
a collar attached to the outer garment, wherein the collar comprises a frontal yoke region for providing additional ballistic and fragmentation protection; and
a helmet providing additional ballistic and fragmentation protection.

2. The protective suit of claim 1 wherein the inner body armor vest is a flexible vest comprised of a plurality of fiber encased ceramic composite discs.

3. The protective suit of claim 1 wherein the inner body armor may be attached to the outer garment by a quick release system.

4. The protective suit of claim 1 wherein the garment is configured to provide protection against high power rifle threats up to and including the .338 Lapua threat, detonation overpressure shock wave, mild steel and high hardness steel fragmentation and shrapnel up to and including 25 mm dimensioned and massed projectiles.

5. The protective suit of claim 1 wherein the helmet comprises an outer shell and an inner shell.

6. The protective suit of claim 1 wherein the upper garment is configured to incorporate a high density light weight dynamic impulse neck restraint to catch the rear of the helmet precluding excessive rearward transmitted motion of the head.

7. The protective suit of claim 1 wherein the upper and lower garment will have multiple emergency quick release systems providing for access into the suit through the front or rear opening designs, and one to each of the outside medial lines of each arm and leg.

8. The protective suit of claim 5 wherein the outer shell comprises a titanium/polymer composite capable of defeating a variety of ballistic Armor Piercing handgun, fragmentation and shrapnel threats.

9. The protective suit of claim 5 wherein the inner shell comprises an energy absorptive layer.

10. The protective suit of claim 7 wherein the energy absorptive layer comprises a resilient high energy impact gel.

11. The protective suit of claim 7 wherein the energy absorptive layer comprises resiliently compressible energy absorbing materials selected from the group consisting of elastomer foams, latex rubbers, synthetic polymers, polyurethane foams, EVA foams, PE foams, neoprene, thermoplastic elastomers and thermoplastic polyesters, EP rubber, silicone rubbers, EPDM rubbers, and closed cell foams.

12. The protective suit of claim 7 wherein the energy absorptive layer comprises a material having a Shore 00 hardness from approximately 12 to 50, utilizing the ASTM D2240 test method.

13. The protective suit of claim 7 wherein the energy absorptive layer comprises a material having an overall density per cubic foot of approximately 25 to 65 utilizing the ASTM D792-00 test method.

14. The protective suit of claim 7 wherein the energy absorptive layer comprises a material having a resilience percentage of approximately 10 to 13 utilizing the ASTM D2632 test method.

15. The protective suit of claim 7 wherein the energy absorptive layer comprises a shear thickening silicone dilatant, fluid or putty added to a textile component or manufactured into a self-supporting elastomeric matrix.

16. The protective suit of claim 13 wherein the energy absorptive layer further comprises particulate reinforcement additives selected from the group consisting of fibrous fillers, plasticizers, extenders, lubricants, and whisker or tubular fillers.

17. The protective suit of claim 7 wherein the energy absorptive layer comprises a putty-like dilatant contained within multiple seamed cells.

18. The protective suit of claim 7 wherein the energy absorptive layer is in the shape of a unitary pad dimensioned to protect the desired head region, or cells laid out into hexagonal or round side-by-side points in a honeycomb configuration or grid.

19. The protective suit of claim 1 wherein the helmet is designed to have a reduced frontal surface profile thereby providing a reduced overpressure shock transfer in the helmet.

20. The protective suit of claim 1 wherein the helmet is designed to utilize an amorphous ceramic ballistic/fragmentation resistant transparent ceramic interface enhancement layer between the polymer outer layer and the internal anti-spall layer.

21. The protective suit of claim 1 wherein the helmet comprises a reinforced face shield anchoring that precludes face shield pull-out during an overpressure shock wave phase.

22. The protective suit of claim 1 wherein the outer garment comprises arm portions and leg portions which are all sewn to a torso portion to form one inseparable garment.

23. The protective suit of claim 1 wherein the outer garment comprises a plurality of gussets in the upper extremity regions and the lower extremity regions of the garment to provide added reinforcement and flexibility.

24. The protective suit of claim 20 wherein the plurality of gussets are formed just below the shoulder in the upper bicep and tricep muscle area, just below the elbow above the flexor and extensor muscle area for each arm, in a diagonal direction through the groin musculature region in the upper leg below the pelvis, and just below the knee and above the major musculature region of the lower leg.

25. The protective suit of claim 1 wherein the outer garment comprises a titanium composite reinforcement strike face.

26. The protective suit of claim 1 wherein the inner body armor provides frontal protection from the abdomen 2 inches below the navel area up to the suprasternal notch, and within 2″ into the upper most arm pit region, and wrapping to the rear with an overlapping joint 2″ past the medial line.

27. The protective suit of claim 1 wherein the suit provides rear energy absorptive layer protection from the C-7 vertebrae downward to the hip region of the pelvis just above the location where the external oblique muscles connect to the pelvis, and wrap around to a medial location.

28. The protective suit of claim 1 further comprising:
an optional lumbar support platform configured to support the vest and the outer garment thereby transferring weight of the vest and the outer garment onto the hips and reducing any compressible weight transfer to the lower lumbar section of the spine.

29. The protective suit of claim 1 wherein an outer surface of the outer garment comprises a webbing attachment system with quick release clips to allow for the attachment of additional armor panels, and tool kit.

30. The protective suit of claim 1 further comprising:
a hydration system attached to the outer garment.

31. The protective suit of claim 1 further comprising:
a communications unit attached to the outer garment to provide communications capabilities to the suit.

32. The protective suit of claim 1 further comprising:
a plurality of drag bars on a rear side of the outer garment, wherein the drag bars are configured to support over 400 pounds of pull without tearing the outer garment off of the body.

33. The protective suit of claim 1 further comprising:
an air cooling circulation system for internal air cooling within the outer garment and helmet.

34. The protective suit of claim 30 wherein the air cooling circulation system comprises a dual piezolelectric cooling jet coupled to a thermoelectric device to facilitate cooling in the absence of a fan.

35. The protective suit of claim 30 wherein the air cooling circulation system comprises a multiple ThinSink™ forced convection unit (miniturized fan cooling technology coupled to a thermoelectric device to facilitate cooling in the absence of a fan.

36. The protective suit of claim 30 wherein the air cooling circulation system and thermoelectric device are coupled to a bifurcated air re-circulating venturi delivery system manifold.

37. The protective suit of claim 1 further comprising:
Small TEC sets of modules with larger pellet footprints.

38. The protective suit of claim 1 further comprising:
A Pulse-Width-Modulated frequency voltage controller.

39. The protective suit of claim 1 further comprising:
A Pulse-Width-Modulated frequency voltage controller capable of operating from 9 volts dc to 24 volts dc.

40. The protective suit of claim 1 further comprising:
Series arranged TEC multiple module configuration.

41. The protective suit of claim 1 further comprising:
Series-parallel TEC multiple module configuration.

42. The protective suit of claim 1 further comprising:
A Pulse-Width-Modulated frequency voltage controller, and multiple TEC modules capable of sustained operation from a single voltage replaceable battery source.

43. The protective suit of claim 1 further comprising:
A Pulse-Width-Modulated frequency voltage controller, and multiple TEC modules capable of sustained operation from dual multi-varied voltage replaceable battery sources.

44. The protective suit of claim 1 further comprising:
Enhanced nickel plating of the TEC module connectors.

45. The protective suit of claim 1 further comprising: Augmentation (back-up) power in one embodiment would be through the use of a flexible extremely thin solar panel attached to the back of the oversuit. the utilization of TE generator harnessing the diffused waste heat from the TEC to generate power to replace used stored energy or the augment as an additional power subsystem.

46. The protective suit of claim 1 further comprising:
the utilization of TE generator harnessing the diffused waste heat from the TEC to generate power to replace used stored energy, or the augmentation as an additional power subsystem.

47. The protective suit of claim 1 further comprising:
an interface ribbed undergarment to facilitate cooling of the personnel.

48. The protective suit of claim 32 wherein the undergarment comprises a Dacron® polyester fiber material and ribs attached to the material.

49. The protective suit of claim 1 further comprising:
an absorbant material within the helmet to facilitate air re-circulation and reduce fog within the helmet.

50. The protective suit of claim 1 further comprising:
a filtering system configured to remove and prevent air born particle recirculation within the suit and helmet also incorporating a desiccant drying system to reduce moisture/humidity within the suit and helmet.

51. The protective suit of claim 1 wherein the outer garment comprises an outer layer and an inner layer, wherein the outer layer is comprised of a water repellant and flame retardant material and the inner layer comprises a rip-stop material.

52. The protective suit of claim 1 further comprising:
a plurality of ballistic or fragmentation resistant panels removeably attached to the outer garment.

53. The protective suit of claim 1 further comprising:
elastomeric and EPDM rubber pads at elbow or knee areas of the outer garment.

54. The protective suit of claim 1 wherein the outer garment further comprises:
a plurality of tourniquets at an arm and upper leg areas that can be set, and once the outer garment is removed, the tourniquets are configured to remain in place precluding hemorrhage bleeding.
